(19) United States
(12) Patent Application Publication
(10) Pub. No.: US 2013/0159396 A1
(43) Pub. Date: Jun. 20, 2013

(54) SYSTEM FOR STORING AND RETRIEVING DATA

(71) Applicant: stkr.it, LLC, Ann Arbor, MI (US)

(72) Inventor: Michael NEWMAN, Brooklyn, NY (US)

(73) Assignee: stkr,it, LLC, Ann Arbor, MI (US)

(21) Appl. No.: 13/716,790

(22) Filed: Dec. 17, 2012

Related U.S. Application Data
(60) Provisional application No. 61/577,011, filed on Dec. 17, 2011.

(51) Int. Cl. H04L 29/06

(52) U.S. Cl. CPC H04L 67/42
USPC 709/203

(57) ABSTRACT

A system and method for storing and retrieving data. Data can be stored by resolving a unique identifier with a device. In one embodiment the unique identifier comprises a bar code and an alphanumeric text string. Thereafter, the server receives a query from the device. Then the device transmits the data from the device to the server.

Once data has been stored on a server, the server can be retrieved by resolving a unique identifier with a device. The server receives a query from the device, and thereafter transmits data from the server to the device.

### CROSS REFERENCE TO RELATED APPLICATION

This application claims the benefit of U.S. Provisional Application No. 61/577,011 entitled “System for storing and retrieving data,” filed Dec. 17, 2011, the entirety of which is hereby incorporated by reference.

### BACKGROUND

1. Field of the Invention

This invention relates to systems for storing and receiving data, and methods of using such systems.

2. Description of Related Art

It is well known to store data on servers, which can then be accessed from remote computers, for example over the internet. Often, such data is organized into groups, which may contain related data, such as image and multimedia files associated with a single event or topic. A single web address may sometimes be used to access a single group.

Web addresses, as well as other data, can be represented either as alphanumeric characters, or encoded in machine-readable form. Quick response codes are an example of machine-readable codes which encode data in two dimensions. This allows a relatively long text string, such as a web address, to be represented in relatively small area.

### BRIEF DESCRIPTION OF THE DRAWINGS

In order to understand the presently disclosed subject matter and to see how it may be carried out in practice, embodiments will now be described, by way of non-limiting examples only, with reference to the accompanying drawings, in which:

FIG. 1 is a schematic illustration of a system according to the presently disclosed subject matter;

FIG. 2 is a schematic illustration of a server of the system illustrated in FIG. 1;

FIG. 3 illustrates a label of the system illustrated in FIG. 1;

FIGS. 4A through 4B illustrate two embodiments of pages of the system illustrated in FIG. 1;

FIGS. 5A through 5D illustrate unique identifiers of the system illustrated in

FIG. 1;

FIG. 6 is a schematic illustration of a device of the system illustrated in FIG. 1;

FIGS. 7 and 8 illustrate methods of using the system illustrated in FIG. 1;

FIG. 9 depicts a system for retrieving data;

FIG. 10 depicts a system for retrieving data;

FIG. 11 depicts a system for retrieving data.

### DETAILED DESCRIPTION

As illustrated in FIG. 1, there is provided a system, which is generally indicated at 10. In one embodiment, the system 10 is designed to facilitate storage and retrieval of data. In one embodiment the system 10 facilitates storage and retrieval of digital data relating to a physical object. As such, in one embodiment it comprises a processing server 12 for processing correspondence and queries from a device 16, storage of unique identifiers 14, and/or storage of data. The system further comprises at least one unique identifier 14, each of which can be associated with a physical object, for example by being affixed thereto and/or by being formed integrally therewith, and at least one device 16, which can be used to provide digital content to the processing server 12, and to retrieve it therefrom. Virtually any type of data can be stored or retrieved. The data can include, but is not limited to audio, video, photos, text, documents such as Word documents, Excel, PowerPoint presentations, computer coding or software, etc. The data can include, but is not limited to, data which was created or recorded by the device 16 and data which is stored on the device 16.

The processing server 12 can be any suitable computer or other storage device which is accessible via a public network, such as the internet. In one embodiment the processing server 12 is in direct communication with the device 16, whereas in other embodiments the processing server 12 is in indirect communication with the device 16. In one embodiment the device 16 is in communication with the cloud. In one embodiment, the processing server 12 is configured to associate a unique identifier 14 with a location of data.

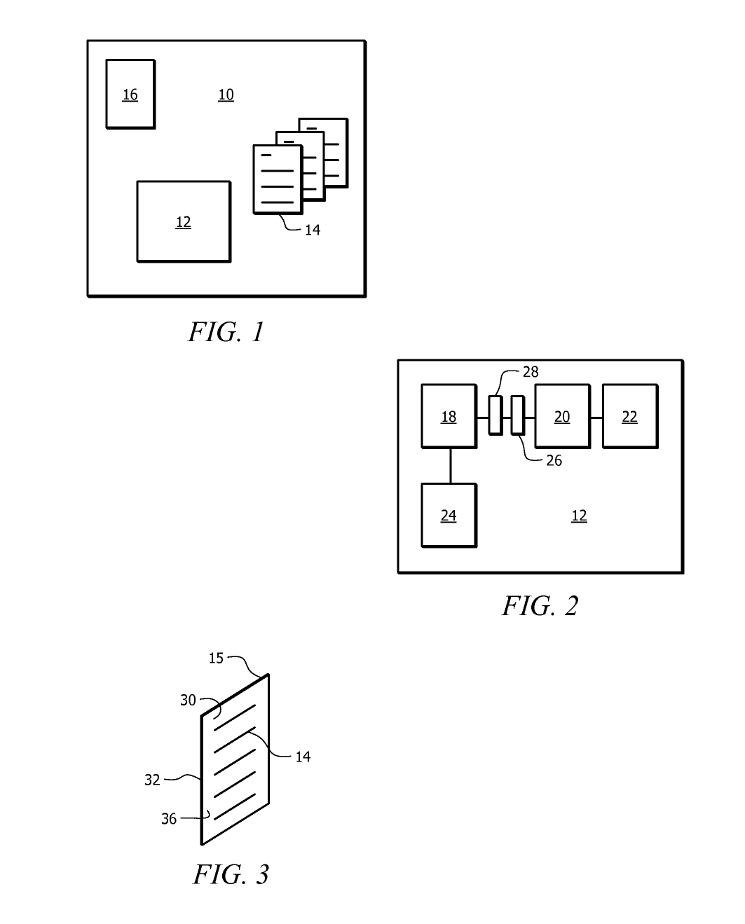

In one embodiment, and as illustrated schematically in FIG. 2, the processing server 12 comprises one or more processors 18, a main memory 20, a secondary storage 22, and one or more network interfaces 24. FIG. 2 is for illustrative purposes only and should not be deemed limiting.

The processor 18 can be any suitable unit or units which are configured to carry out the functions of the processing server 12 and can be physically provided as a single chip such as a microprocessor, as several units, e.g., spread over one or more printed circuit boards, or as any other suitable configuration.

The main memory 20 can be any suitable unit or units which store data to be processed by the processor 18. One or more memory busses 26 can be provided between the main memory 20 and the processor 18 to facilitate the transfer there between, with a memory management unit 28 being provided there between to manage access to memory requested by the CPU. The main memory 20 can comprise volatile memory, and may be provided as random access memory (RAM) chips.

In one embodiment, the secondary storage 22 is configured to maintain data which is to be stored long-term. It can include data uploaded by a user, and software which is used to operate the processing server 12, such as an operating system and/or applications. The secondary storage 22 can include one or more hard disks, flash memory devices, or any other suitable storage medium.

In one embodiment, the network interface 24 is configured to allow access to the processing server 12 by outside computers and to facilitate access of outside computers by the processing server 12. The network interface 24 can comprise any suitable device, such as on board or add-on network interface cards. It may comprise a wired connection and/or a wireless connection.

In addition to the above elements, it will be appreciated that the processing server 12 can comprise any other suitable elements, such as a dedicated terminal and/or input devices, removable storage, backup devices, etc., without departing from the scope of the presently disclosed subject matter, mutatis mutandis.

According to some embodiments, for example as illustrated in FIG. 3, at least one label 15, wherein at least one label 15 comprises a unique identifier 14 thereupon, is provided together, for example as a set or together in a single package. As depicted, each label 15 comprises an obverse side 30 and a reverse side 32. As depicted, and in one embodiment, the unique identifier 14 is printed thereupon on the obverse side. As noted above, each unique identifier 14 is unique such that the information encoded or otherwise represented thereby can be differentiated from the identifiers of other unique identifiers 14.

In one embodiment, and as depicted, the reverse side 32 of the label 15 is provided with an adhesive, facilitating its affixing to another object. A non-adhesive backing (not illustrated) can be provided, in order to prevent the label 15 from adhering to a surface prior to its use.

The label 15 can further comprise a plastic or other protective coating 36 on its obverse side 30. The coating 36 is applied over the identifier 14, such that it protects it from wear which can render it unreadable, in particular by computer software configured to decode a matrix or linear barcode, or to recognize text. In one embodiment, the coating 36 is transparent or translucent, in order to facilitate viewing of the identifier 14 therethrough.

In one embodiment the unique identifier 14 comprises a cover which conceals the unique identifier 14. The cover can comprise a pull-tab wherein the cover is removed, or the cover can be removed with other methods such as being scratched off. Virtually any method in which the unique identifier 14 can be concealed and then revealed can be utilized.

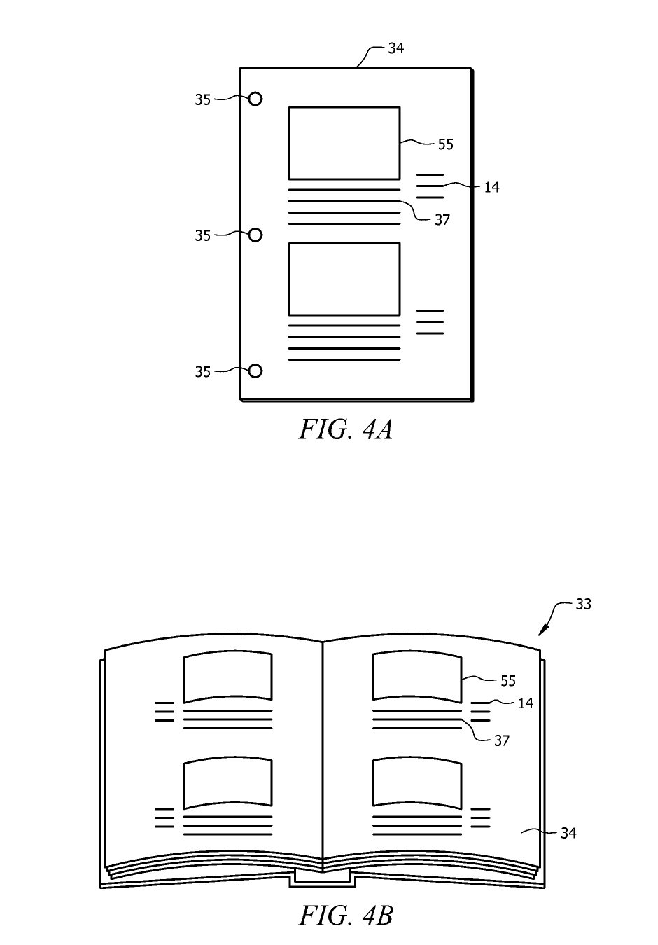

According to other embodiments, for example as illustrated in FIGS. 4A and 4B, one or more pages 34, each with one or more unique identifiers 14 thereupon, are provided. It will be appreciated that the pages 34 may be any type of flat sheet, such as made of paper, cardstock, paperboard, plastic, etc. FIG. 4A depicts wherein the unique identifier 14 is depicted adjacent to a photograph 55 and text 37. In such embodiments the unique identifier 14 provides an opportunity to post data which will accompany the photograph 55 and text 37. In one embodiment, the unique identifier 14, being placed near or adjacent to the photograph 55 and/or the text 37, is visually identified with the photograph 55 and/or the text 37. In this way, each of the photograph 55 and/or text 37 is unambiguously associated with a unique identifier 14. In one embodiment the page comprises indicia indicating where the unique identifier 14 should be placed. In one embodiment the unique identifier 14 is in the form of a label which is affixed to the page 34. In other embodiments, however, the unique identifier 14 comprises ink which is printed directly on the page 34. In such an embodiment, there is no need to affix a label to a page because the unique identifier is printed directly onto the page 34 or other physical object.

In one embodiment, the pages 34 can be configured for being bound in a book, as illustrated in FIG. 4A, or can be provided bound in a book 33, as illustrated in FIG. 4B, and thus can be used in assembling a scrapbook, or other similar bound journal. According to the embodiment illustrated in FIG. 4A, each page 34 can comprise a binding arrangement 35 on or near a margin thereof. The binding arrangement 35 can be, for example, circular holes fanned along one side of the page 34, as illustrated. Alternatively, the binding arrangement 35 can be any other suitable type of aperture. Alternatively, the binding arrangement 35 can be any type of arrangement, such as loops or hooks attached to the page 34 which is configured for facilitating their binding into a book. According to other embodiments, the pages 34 are made of cardstock or paper having a high basis weight. While an embodiment wherein the unique identifier 14 is on a book has been described, other embodiments are described herein including greeting cards, post cards, business cards, etc.

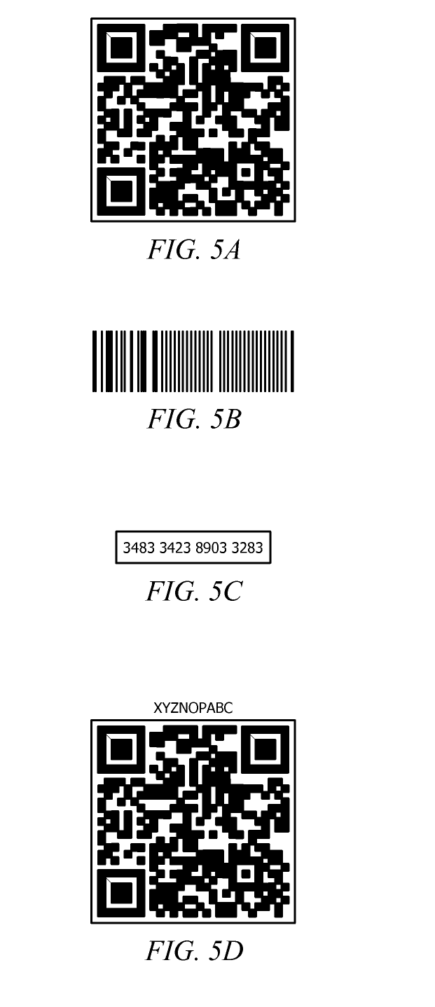

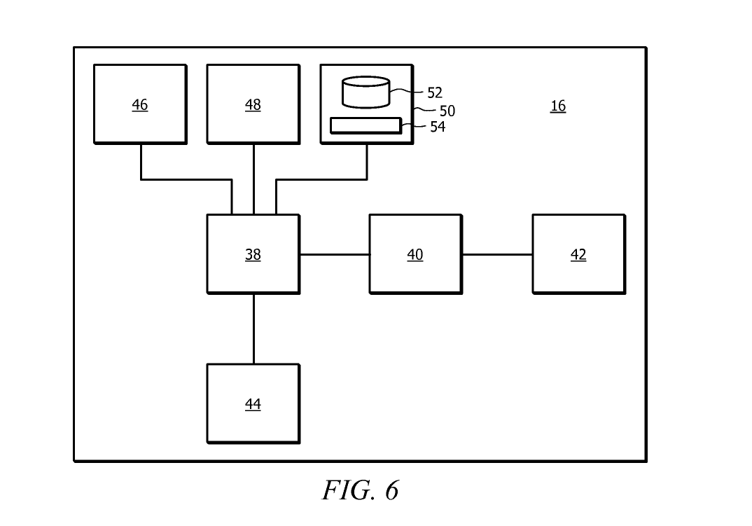

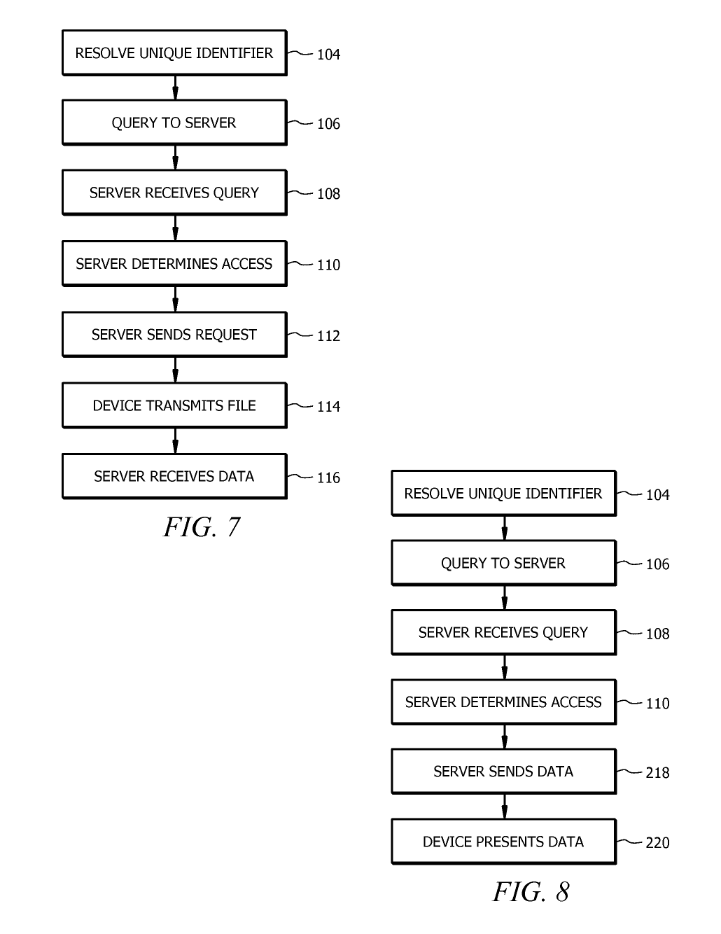

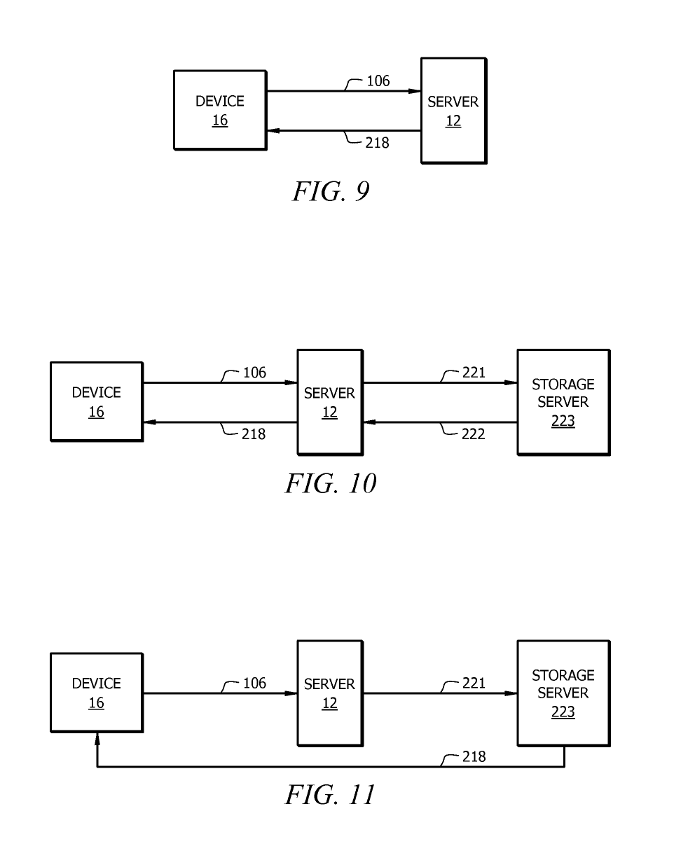

According to any of the above embodiments, each unique identifier 14 relates to a location on a server. It may be in the form of machine-readable code, such as a matrix barcode such as a Quick-Response code, a Data Matrix code, or a stacked barcode as illustrated in FIG. 5A, as a linear barcode as illustrated in FIG. 5B, as an alphanumeric text string as illustrated in FIG. 5C, or other types of marking which can be identified, and combinations thereof. In one embodiment the unique identifier 14 comprises a photograph or drawing. After scanning the photograph or drawing, software captures unique qualities of the photograph or drawing and thereafter the photograph or drawing can be utilized as a unique identifier 14. In one embodiment the unique identifier 14 comprises handwriting. As with the photograph, software scans and recognizes unique attributes of handwriting such that the handwriting functions as a unique identifier 14. Thereafter, the unique identifier 14 can be resolved to retrieve or store data. In one embodiment, the unique identifier 14 comprises a link. In such an embodiment when the link is activated, such as by clicking, data associated with the link is retrieved. Thus, in one embodiment a user can click or otherwise activate a unique identifier 14, such as a photograph, and data is retrieved. As an example, in one embodiment a photograph of a scrapbook is a unique identifier 14 which comprises a link. When a photograph of a girl riding a horse is activated, such as via clicking the photograph, the data associated with the photograph, such as a video of a girl riding a horse, is retrieved.

The unique identifier 14 need not be limited to two dimensional objects. In one embodiment a unique identifier 14 comprises acoustic bar codes. Acoustic bar codes are ridges on a surface such as plastic. When the ridges are rubbed they emit a specified sound. This sound can be recorded on a microphone and used to identify a location on a server. Likewise, in one embodiment the unique identifier 14 comprises Braille. Braille provides a benefit of allowing the visually impaired to decipher the identifier and enter it into a device. Further, in one embodiment the unique identifier 14 can comprise a radio-frequency identification tag, a near field communication compliant device, or other similar element. The identifier can also be printed in such a way that it is visible only under certain frequencies of light. These elements can be read by a device. In still another embodiment, the unique identifier 14 comprises conductive ink. Touch screen devices operate by allowing a human finger to complete a circuit, thereby notifying the device of the location of a finger. Conductive ink works in a similar fashion when applied to the face of a touchscreen device. The touchscreen resolves the conductive ink which points to a location on a server.

In one embodiment the unique identifier 14 comprises a hybrid identifier, i.e., comprising two or more types of identifiers. As an example, in one embodiment the unique identifier 14 comprises a bar code as well as an alphanumeric text string code. A bar code is any machine-readable code which does not comprise letters or numbers. In one embodiment, a machine-readable code comprises a code which cannot be deciphered without the aid of a machine. For example, traditional two-dimensional bar codes and Quick-Response codes are two examples of a bar code as used herein. Likewise, a radio-frequency identification tag is an example of a machine-readable bar code. An alphanumeric text string is a code which comprises letters, numbers, or a combination thereof. FIG. 5D depicts a hybrid unique identifier 14 which comprises a Quick-Response code as well as an alphanumeric text string.

In one embodiment, both codes relate to the same location on the server. For example, both the Quick-Response code and the alphanumeric text of FIG. 5D relate to the same data on a server. Thus, the user can either scan the Quick-Response code or manually enter the alphanumeric text to resolve the unique identifier and retrieve or upload data. Such an embodiment provides flexibility to the user. If, for example, the camera function on a smart phone is broken, the user can manually enter the code and retrieve or upload a message. Likewise, if a user does not have a smart phone, this feature allows the user to store or retrieve data. Further, if the Quick-Response code or other unique identifier 14 is smudged, torn, or cannot otherwise be resolved, the other unique identifier 14, or the alphanumeric text, provides a backup method. Another benefit of the hybrid unique identifier 14 is that it allows users who lack the physical abilities to operate a camera to store and retrieve data. For example, a child who cannot hold a camera sufficiently still to allow the image to be resolved can manually input the alphanumeric text and store or retrieve data.

In other embodiments, however, the two hybrid unique identifiers 14 do not relate to the same data on a server. Referring still to FIG. 5A, in one embodiment the Quick-Response code relates to data on a server whereas the alphanumeric text serves a different purpose such as providing credential information used to gain access to the server. In other embodiments, for example, the Quick-Response code can act as the master code whereas the alphanumeric text acts as a subcode. For example, the Quick-Response code can take the user to the beginning of a photo album whereas the alphanumeric text takes the user to a specific photo.

In one embodiment the unique identifier 14 can comprise a digital representation of the physical object. For example, in one embodiment the unique identifier 14 is on the front page of a magazine. When a user scans the unique identifier 14, the user retrieves the magazine in a digital format. For example, the user can retrieve scanned copies of the interior pages or a scanned copy of the entire magazine. This embodiment provides a method to store and retrieve the content within a physical document.

In one embodiment the unique identifier 14 comprises a generic component. A generic component is a component which by itself is generic but when combined with a unique identifier 14 acts as a unique identifier. For example, a traditional gold star. In some embodiments, a traditional gold star may not be sufficiently unique to act as a unique identifier 14. However, when combined with a master unique identifier 14, the gold star can operate as a subset of the master unique identifier 14. For example, in one embodiment a Quick-Response code acts as the master unique identifier 14. When resolved, the unique identifier 14 takes the user to a first page of a book, for example. Next, the user resolves the gold star. As noted, in one embodiment, the gold star alone is not unique, but when the gold star is associated with the Quick-Response code, the gold star acts as a unique subset. Thus, resolving the gold star can take the user to a second page in a book, for example. Likewise, a blue star when resolved can take the user to a third page of a book. A generic component when associated with a unique identifier 14 acts as a unique identifier. Such an embodiment allows for the utilization of otherwise generic components to act as unique identifiers.

The unique identifier 14 can be affixed to a physical object such as a book or magazine or mug, fabric such as clothing or quilts, key chains or medicine bottles, as well as other printing mediums such as invitations, cards, gift cards, gift card holders, tattoos, frames, notebooks, calendars, tombstones, plaques, cribs, stuffed animals, wrapping paper, gift bags, floral cards, enclosure cards, maps, business cards, year books, etc. The unique identifier 14 can be affixed to any such object with any attaching method known in the art including adhesives, threads, glue, or the like. While in some embodiments the unique identifier 14 is affixed onto a physical item via a label or tag, in other embodiments the unique identifier 14 is integrated onto the item. For example, when printing a book, rather than being affixed afterwards, the unique identifier 14 can be printed directly onto the page, packaging, or physical product. When a unique identifier 14 is placed directly upon the page, packaging, or product, without the use of a subsequent label or tag which comprises the unique identifier 14, the unique identifier 14 is said to have been pre-printed. In some embodiments the unique identifier 14 is implanted into an item. For example, if the unique identifier 14 is a radio frequency identification tag, the tag can be implanted into an object such as a toy. In another embodiment, the unique identifier 14 can be displayed on a screen such as a computer screen or television. For example, a website can display a unique identifier 14.

As noted, the unique identifier 14 corresponds to a location of data on a server. For example, a matrix barcode printed on one of the labels 15 can encode a uniform resource identifier, e.g., a uniform resource locator, of a website uniquely corresponding to a location on a server, and a linear barcode or alphanumeric serial number may present a serial number or other text string which uniquely corresponds to a location on a server. The utility of such an encoding will become clear from the description of the subject matter below.

In one embodiment, the unique identifier 14 is read by a device 16. The device 16 can be any device which is configured for reading the unique identifier 14, decoding and/or recognizing it, and/or communicating with the processing server 12. In addition, it can have other capabilities, which will be apparent from the foregoing description to one having skill in the art.

In one embodiment, the device 16 is provided as a computer, such as a PC workstation, a laptop computer, a handheld computer, or a phone such as a smartphone, and thus can have the basic elements described above with reference to the processing server 12. In one embodiment, and as schematically illustrated in FIG. 6, the device 16 can comprise one or more processors 38, a main memory 40, a secondary storage 42, and one or more network interfaces 44. FIG. 6 is for illustrative purposes only and should not be deemed limiting. According to some examples when the device 16 is a smartphone, the network interface 44 can be an antenna configured to communicate with a cellular network. In addition, the device 16 comprises one or more user input interfaces 46, data presentation modules 48, and visual sensors 50.

The user input interface 46 can include one or more devices configured for allowing a user to communicate with the device 16, for example to direct operation thereof. Examples of devices which can constitute part of the user input interface 46 include, but are not limited to, pointing devices, keyboards, microphones (e.g., for voice recognition), touch-sensitive screens, and motion sensors.

The data presentation module 48 can include one or more devices configured for facilitating the device 16 displaying or otherwise conveying information to the user. Examples of devices which may constitute part of the data presentation module 48 include, but are not limited to, monitors, screens, speakers, and indicator lights.

In one embodiment, the device 16 comprises a visual sensor 50. The visual sensor 50 can include one or more devices configured for allowing the device 16 to image a physical object. The visual sensor 50 can include any device including a combination of hardware and software which allows the device 16 to image a physical object. One example of a visual sensor 50 is optics 52 designed to face the object, and a photo detector 54 therebehind. The optics 52 can include one or more lenses configured for focusing light impinging thereon onto the photo detector 54. The photo detector 54 can be any suitable element, such as a CMOS sensor, a charged coupled device, etc.

The device 16 can be loaded with software which facilitates its communication with the processing server 12 based on information encoded in the unique identifiers 14. To that end, the software can be configured to facilitate the device to perform some or all of the operations listed below.

The software can be configured to operate the visual sensor 50 to capture an image of a nearby object, for example, one of the unique identifiers 14. According to one example, the software selectively directs the device 16 to utilize its data presentation module 48 to prompt the user to issue a command to image the identifier 14. It can further direct that an image corresponding to that currently being captured by the photo detector 54 be displayed on the data presentation module 48. The software can be configured to automatically recognize that the unique identifier 14 is being imaged, or it can be configured to allow a user to indicate such, for example via the user input interface 46. In one embodiment, the software is configured to subsequently store an image of the unique identifier 14. The image of the unique identifier 14 can be stored in the device, for example, in the device's 16 main memory 40 or in its secondary storage 42.

It will be appreciated that the above functionality is optional, in that the unique identifier 14 can be provided as a text string, in which case the software can be configured to direct the device 16 to prompt the user to input the string manually. It will be further appreciated that the software can be configured to have both of the above functionalities, and can direct the device 16 to prompt the user to select which of the two functions he wishes to utilize during use, or to detect which type of supported identifier has been imaged.

In addition, the software can be configured to instruct the device 16 to decode and/or recognize the captured image of the unique identifier 14. As such, it may be preloaded with data relating to a barcode in the event that the identifier comprises a matrix or linear barcode and/or with optical character recognition capabilities in the event that the identifier comprises an alphanumeric text string. It will be appreciated that in the event that the identifier is input manually by the user, as described above, this functionality may be optional.

The software can be further configured to direct the device 16 to communicate, via its network interface 44, with the processing server 12 and access a specific location thereof based on the information decoded, recognized, and/or input manually, as described above. In the event that the identifier 14 encodes a uniform resource identifier of a location on a server, the software is configured to direct the device 16 to access that location. In the event that the unique identifier 14 encodes a text string which corresponds to a location on the server, and not a complete uniform resource identifier, the software can be preconfigured to supply missing information required to access the location, including, but not limited to, the server name. For example, the software can be configured to determine the complete uniform resource identifier of the location on a server based only on the text string.

The software can be further configured to direct the device 16 to record content provided by the user. For example, it may be configured to utilize one or more of the user interfaces 46 and/or visual sensors 50 to record audio and/or visual content, e.g., an audio or video clip. In one embodiment, the clip is stored on the device 16. For example, the clip can be recorded directly to the secondary storage 42, buffered to the main memory 40 and then subsequently recorded to the secondary storage, or buffered to the main memory and then subsequently transmitted to a remote location such as the processing server 12 via the network interface 44.

As discussed, the data to be stored can come from virtually any source. In one embodiment the data comes from data recorded by the device. In another embodiment the data comprises data which was previously stored on a device or server. In one embodiment wherein the user is recording data, the user creates digital chapters indicating where to create breaks in the recording. Thus, when a third-party retrieves the data, the third party advances through the chapters by directing the computer or device to proceed. This direction can comprise pressing a key on a keyboard, swiping a finger across a screen, etc. Digital chapters allow data, such as a multimedia message, to be broken into smaller pieces and presented. One example includes a story whereby a first chapter is first presented. The user then selects to continue and a second chapter is presented. Likewise, data can comprise a slide show whereby the user selects to view the next slide.

The system 10 can be configured to perform methods by which information may be stored to and retrieved from a location on a server, such as the processing server 12, via the device 16, in correlation with information represented on each of the identifiers 14.

According to some embodiments of the method, as indicated at 100 in FIG. 7, a user utilizes the system to store information, such as a multimedia or other computer file, at a location on a server, such as the processing server 12. The location may be a directory or database location uniquely identified by one of the unique identifiers 14.

In the resolving step 104, the device 16 resolves the unique identifier 14, such as by decoding and/or by recognizing it, as appropriate, as described above. As used herein, resolving refers to a method of identifying the unique identifier 14. The resolving step 104 can comprise decoding, such as decoding, for example, a QR code, bar-code, or other type of unique identifier 14. In one embodiment, the resolving step 104 comprises using the device 16 to scan and resolve the unique identifier 14.

In one embodiment the resolving step utilizes specific software on the device 16 which is specific to the type of unique identifier 14. For example, specific software can be utilized to decode a specific type of unique identifier 14. As an example, in one embodiment Company A controls the processing server 12 and creates the unique identifiers 14. A user can utilize software developed by Company A to create or retrieve data associated with the unique identifier 14. The software can be downloaded on a computer, downloaded as an application on a smart phone, or via other methods software is stored. As used herein, specific software refers to software which is required to retrieve data from a specific source. In other embodiments, however, specific software is not necessary. For example, assuming Company A owns the processing server 12 and creates the unique identifier 14, in one embodiment the user does not require software developed by Company A to create or retrieve data. In such embodiments, the device 16 resolves the unique identifier 14 via generic software which is not specific to Company A. Not requiring users to download software specifically directed to a specific company is an unexpected benefit. Consumers will be less likely to retrieve data if they are required to download specific software to do so. For example, if there are two companies, Company A and Company B, if specific software was required the user would be required to have both Company A's software and Company B's software to retrieve data associated with both companies. However, allowing generic software, such as Quick Response decoding software, to resolve Company A's unique identifier 14 gives Company A an unexpected advantage. Thus, in one embodiment the system comprises specific software whereas in other embodiments the system utilizes generic software to create and/or retrieve data.

In one embodiment the resolving step 106 automatically determines what kind of data can be stored and/or retrieved. For example, rather than having to utilize a specific unique identifier 14 for a picture, the resolving step 106 automatically determines what type of data, such as audio, video, or text, is supported. If this were not the case, then certain unique identifiers 14 could be used only for audio data whereas different unique identifiers 14 could be used only for video, and the user would have to know of these limitations. In one embodiment, these limitations, to the extent they exist, are automatically relayed to the user. This is an unexpected benefit which results in increased flexibility.

In one embodiment the resolving step 106 comprises manually inputting the unique identifier 14. For example, in one embodiment wherein the unique identifier 14 comprises an alphanumeric text, the text is typed or otherwise entered into the device 16. In one embodiment, these actions constitute resolving the unique identifier 14 with the device 16. In other embodiments manual entry is unnecessary, as described above. As an example, in one such embodiment wherein the unique identifier 14 comprises, for example, a Quick Response code as depicted in FIG. 5A, the resolving step 104 comprises using the device 16 to scan or otherwise view and decode the image.

After the resolving step 104, in one embodiment the device 16 sends a query to the server 12 in the query step 105. The query step 105 can comprise both a direct query whereby the device 16 communicates directly to the processing server 12 as well as indirect queries whereby the device 16 communicates with intermediary devices before the query is received by the processing server 12. The query can include information resolved from the unique identifier 14. The query can also include information regarding a location on a server, including the processing server 12. In one embodiment the query comprises a request for information and/or data. In one embodiment the query comprises information related to a user's library located on the server. In one embodiment the query comprises seeking to see if there is already data which is associated with the unique identifier 14. In another embodiment the query comprises seeking to determine what level of access, for example read or write access, has been granted.

The processing server 12 receives the query in the receiving step 108. In one embodiment, after the processing server 12 receives the query from the device 16, the processing server 12 sends confirmation that the query was received.

FIG. 7 depicts an optional access step 110. In the access step 110, the processing server 12 makes a determination regarding a level of access to grant the device 16. Possible levels of access include, but are not limited to, transmitting a computer file to the location, receiving a computer file from the location, replacing a computer file stored at the location, editing a computer file stored at the location, associating a computer file stored on the server with the location, deleting a computer file stored at the location, and associating a string of text with a computer file stored at the location. The processing server 12 may make the determination based on one or more of several factors, including, but not limited to, the number of previous times the location has been accessed, credentials supplied by the device 16, and amount of information stored at the location relative to a predetermined storage and/or bandwidth usage quota. In one embodiment the processing server 12 sends a request to the device 16 to supply necessary credentials, or the credentials may be provided with the device's initial query. Thus, in one embodiment, the query step 106 further comprises credentials. Credentials, as used herein, refer to information used to gain access to a server. In one embodiment credentials comprise log-in information, passwords, proof of purchase, etc. As noted in one embodiment the credentials include proof of purchase. Such an embodiment prevents or reduces theft of unique identifiers 14.

In the request step 112, the processing server 12 sends a request to the device 16. The request can include a variety of information including informing the device 16 about the level or levels of access which has been granted. The request can also include metadata associated with the unique identifier 14.

Thereafter, in the transmitting step 114, the data is transmitted from the device to a server, such as the processing server 12. The transmitting step 114 can comprise any type of transmission including wireless transmission, wired transmission, and combinations thereof. The data can comprise virtually any type of data described above including multimedia data.

In one embodiment the data comprises data which was made or captured by the device 16. For example, if the device 16 is a computer with a webcam, the data can comprise a video captured right at the device 16. Likewise, if the device 16 is a smartphone, a video can be made with the device 16. This eliminates the step of capturing data with a different device such as a camera and then downloading that data onto a different device 16 such as a computer. Thus, in one embodiment the data is created on the device 16 prior to the resolving step 104. For example, the user can utilize the device 16 to create a personalized message. Thereafter, the unique identifier 14 is resolved with the device 16. In other embodiments, however, the data is created after the resolving step 104.

As noted, virtually any data can be stored. The data can be pre-stored or the data can be created by the device. As noted, the data can comprise a multimedia message such as a “Happy Anniversary” message accompanying a gift. In one embodiment the unique identifier 14 is affixed, either by sticker or by being directly printed upon, a business card. This provides the user an opportunity to, for example, record a meeting. The user could then later retrieve the recorded meeting by resolving the unique identifier 14. Likewise, the unique identifier 14 can comprise data related to a sales pitch. The unique identifier 14 can be used to retrieve sales data, photos, etc.

In one embodiment software is utilized to record the data to be stored. In one embodiment the software utilizes a template to create the message. For example, the template can comprise a green screen whereby visual effects can be manipulated. In such an embodiment, software allows a person to be recorded in her office but the software manipulates the data such that it appears the person is recording the message on a beach in Hawaii. Likewise, sound and other effects can be modified.

After the transmitting step 114, the data is received by a server, such as the processing server 12 in the receiving step 116. In one embodiment, after receiving the data a server stores the data. As will be discussed in more detail below, the data can be stored on the processing server 12 or on other storage servers. In one embodiment, the data is stored in a location corresponding to the unique identifier 14 such that the data can be retrieved via the unique identifier 14. The data can be stored in any manner utilized by a server, but in one embodiment, the data is stored in a user's library. A user's library is a library of the user's stored data. For example, the user can have several messages, videos, photos, etc. stored on the server 12. By storing the data in a user library, the user can edit, modify, and otherwise change the stored data. For example, after a user utilizes a device 16 to transmit data, the user can log into the server and review his or her library. The user can then add captions, comments, etc. to the data. The user can also add restrictions as to who can retrieve the data, the number of times the data can be retrieved, etc. In one such example, a band records a song associated with a unique identifier 14. The band can then state that they will only allow 1,000 views or downloads. This ability offers the original user, the person who stored the data, an opportunity to control the dispersal of the data.

In one embodiment the user is notified when a message has been read. For example, when a third-party user reads a message, the user is notified. The notification can be via email, text, etc. This provides the user a way to catalog the number of views, downloads, etc. This also provides the original user confirmation that a third-party has received and retrieved the message.

In one embodiment, after the data is stored on a server, such as the processing server 12, the user is provided a link which links to the data stored on the server. The link can comprise a hyperlink, a URL, or any other link which links to the data stored on the server. The link can be transmitted to the device or to the user of a device via text, email, etc. The link, such as a hyperlink, in one embodiment, acts as a unique identifier 14 to direct a user to a website to retrieve the stored data. This provides the original user an additional avenue with which to share the data. For example, after a user has stored data, the user can affix a unique identifier 14 on a scrap book so the data can be later retrieved. However, if the user also wants to share the data with friends or family that may not have access to the scrap book, the user can post a hyperlink to Facebook, Twitter, etc., or the user can email the link. This benefit provides the use at least two methods to share the data.

In some embodiments, the device 16 needs to receive some information from the processing server 12 before data can be transmitted to the processing server 12. For example, in one embodiment the device 16 acquires acceptable format types, size allotment, etc. This information referred to storage requirements. Storage requirements refer to limitations or requirements that must be met before data can be stored. In one embodiment the processing server 12 sends storage requirements to the device 16. In another embodiment the processing server 12 does not send storage requirements with the device 16 but instead receives the transmitted data and determines if the storage requirements have been met. If the storage requirements have been met, the data is stored. If the storage requirements are not met, the data is not stored and the device 16 is notified. In one embodiment, the query step 105 comprises a query for storage requirements.

In one embodiment the storage requirements are obtained in other avenues. For example, if the device 16 has a program or application for uploading data, the storage requirements can be included into the program or application. In such an embodiment, the storage requirements are not obtained from the processing server 12. By eliminating the step of sending storage requirements from the processing server 12, the duty on the processing server 12 is reduced which reduces operating and capital costs.

In one embodiment, the message associated with a unique identifier 14 is selected from data already stored, or pre-stored data. Pre-stored data is data which is already stored and can already be retrieved from a server. In some embodiments a user wants to associate a unique identifier 14 with pre-stored data. For example, a user wants to associate a unique identifier 14 with a video from You Tube. In such an embodiment, the user resolves a unique identifier 14 as previously described. The user then sends a query to the processing server 12. The processing server 12 then sends a request to the device 16. The device 16, instead of transmitting data, transmits a link to data. The link may include a hyperlink, a URL, a location on a server, or any other type of information which refers to the location of data. The processing server 12 then associates the link with the unique identifier 14. Thereafter, when a third-party resolves the unique identifier 14, the third-party retrieves the link and is able to retrieve the linked data.

In one embodiment a user is prompted to select data from a catalog of pre-stored data. A catalog of pre-stored data is a database of available data. The data can comprise any type of data previously described. The catalog can include a number of available pre-stored data which the user can select. For example, the catalog can include common songs, common speeches, popular movie clips, animal recordings, audio books, etc. This catalog is presented to the user via the device. The presentation can include a list of available data to be selected. In one embodiment, the presentation includes a sampling from the pre-recorded data. For example, if the user wishes to associate the Happy Birthday song with a unique identifier 14, the user selects the Happy Birthday song. A user can purchase a gift, and wrap the gift with giftwrapping which comprises a unique identifier 14. The user selects the Happy Birthday song. The processing server 12 thereafter associates the unique identifier 14 with the selection of the pre-stored data. Thereafter, upon receipt of the gift, a user resolves the message and retrieves the Happy Birthday song message. This provides the user an opportunity to provide a message without having to first record a message. Further this provides an opportunity to provide a message even if the user does not have recording capabilities, thus increasing the pool of potential users.

In another embodiment the gift is purchased from an on-line retailer who wraps and ships the product with a unique identifier 14. The user is allowed to store data associated with the unique identifier 14 without ever having seen the unique identifier 14. The data can comprise any data discussed herein including a selection from a catalog of pre-stored data.

In one embodiment the data comprises a hybrid of catalog pre-stored data as well as personalized data such as a personalized recording. For example, in one embodiment, the user creates a personalized audio message which states “Happy Birthday from Grandmother.” Thereafter, a catalog pre-stored audio recording of a book is read. Such an embodiment allows for the personalization of catalog pre-stored data.

In one embodiment, data is associated with a unique identifier 14 and the unique identifier 14 is placed in a calendar. Thus, a user can retrieve data which is tagged or posted in a specific day on a calendar. The data can be any data discussed herein. In one embodiment the data comprises a reminder.

In another embodiment, data is associated with a unique identifier 14 and the unique identifier 14 is used in a scavenger hunt. For example, a first unique identifier 14 provides a clue for the location of the second unique identifier 14.

According to some methods, for example as indicated at 200 in FIG. 8, once data associated with a unique identifier 14 has been stored on a server, the unique identifier 14 can be used to facilitate its retrieval. Many of the same or similar steps are utilized in FIG. 8 as in FIG. 7. In the resolving step 104, the device 16 resolves the unique identifier 14. The resolving step 104 can take place as described above. Next, during the query step 106, the device 16 sends a query to the processing server 12. Thereafter, the processing server 12 receives the query during the receiving step 108.

FIG. 8 depicts an optional access step 110, which was described in regard to FIG. 7. Thereafter, the processing server 12 sends the data in the transmission step 218. The transmission step can include direct and indirect transmission. The transmission can be wired, wireless, or a combination thereof.

After the processing server 12 sends the data, the device presents the data in the presenting step 220. The presenting step 220 can comprise virtually any method of presenting data. If the data is audio then the presenting step can comprise playing the audio. If the data comprises video or graphics the presenting step can comprise displaying the video or graphics. In one embodiment, the device 16 is allowed to download and store the data.

After the data is stored on a server, a third-party user, either the original user which stored the data or a different user or users can access the data via the unique identifier 14. As an example, a third-party user obtains a unique identifier 14. The third-party user then resolves the unique identifier 14 with a device in any of the methods discussed herein. The device 16 then sends a query to the processing server 12, and a server transmits the data to the device 16. Finally, the data is displayed on the device 16.

In one embodiment the third-party user is granted read-only access meaning that the third-party can only view the stored data. In other embodiments, however, the third-party user is granted write access. Write access allows the third-party user to comment or otherwise add data associated with the unique identifier 14. In one example, the user creates and stores a message. A third-party which later views the message, if granted write access, can add comments to the video. Thus, the original user can receive feedback from third-party users. In another embodiment, the third-party adds a message which can comprise any data including text, multimedia, images, etc. As an example, a user creates a message accompanying a gift. The third-party reads the message and creates a thank-you message that the original user can then retrieve. The user can then create a response to the third-party user's thank-you message. Thus, in such an embodiment the messages exist as a string of messages such as a conversation. In other embodiments the third-party creates a message which replaces the original user's message.

FIG. 9 depicts a system for retrieving data. A similar system can be used for storing data. As previously discussed, the device 16 sends a query 106 to the processing server 12. As depicted, the processing server 12 receives the query 108 and can optionally determine the access 110. Thereafter the processing server 12 sends data 218 to the device 16. Accordingly, in such a system the unique identifier 14 corresponds to a location of data on the processing server 12. In one embodiment, the user's library is stored on the processing server 12.

As depicted in FIG. 9, the device 16 communicates directly with the processing server 12. Put differently, the same processing server 12 which receives the query 106 also sends the data 218. This provides an advantage of reducing the amount of servers with which the device 16 must communicate. It provides a centralized location, specifically processing server 12, on which all of the correspondence with the device 16 occurs. This is a benefit as it minimizes the amount of hardware which must be utilized. This reduces capital cost and reduces operating expenses as a single server must be maintained. Further, this system decreases complexity.

FIG. 10 depicts a system for retrieving data. A similar system can be used for storing data. FIG. 10 comprises a processing server 12 and a storage server 223. The storage server 223 can be any type of server previously discussed. In one embodiment the storage server 223 is designed for large data storage. Those skilled in the art will understand that some servers are designed for computations whereas other servers are designed for data storage.

As depicted in FIG. 10, the device 16 sends a query 106 to the processing server 12. The processing server 12 then sends a data request 221 to the storage server 223. The storage server 223 provides the requested data 222 to the processing server 12. The processing server 12 then sends the data 218 to the device 16. Thus, the processing server 12 is a centralized server on which all correspondence with the device 16 occurs. Put differently, the device 16 does not communicate directly with the storage server 223. This has many benefits. If the device 16 communicated directly with the storage server 223, the storage server 223 would have to be designed to handle such requests. The storage server 223 would require the capacity and ability to interact with the device 16. Further, the storage server 223 would require security safeguards to minimize and monitor its correspondence with device 16 to limit access. However, as depicted, the storage server 223 need only communicate with the processing server 12. The processing server 12 handles all correspondence with the device 16. Thus, the processing server 12 has the ability and capacity to interact with the device 16. Further, the processing server 12 has the ability to ensure necessary safeguards when interacting with device 16. In one embodiment, the processing server 12 will have the bandwidth to handle requests and communications with the device as well as transmit the data received from the storage server 223.

Another benefit of the system in FIG. 10 is that the storage server 223 can be designed to store bulk data. Often, a storage server dedicated to store bulk data can do so more efficiently, and at a reduced cost, compared to storing bulk data on a processing server such as the processing server 12. This provides the ability to specialize equipment. For example, the processing server 12 can be designed to correspond with the device 16 by receiving and processing queries. The storage server 223 can be optimized to store bulk data. As noted, such specializing and optimization reduces both capital and operating costs.

As noted, one benefit of the system in FIG. 10 is the ability of the processing server 12 to track correspondence with the device 16. If, for example, data was sent from the storage server 223 directly to the device 16, as opposed of data being sent from the processing server 12, then the processing server 12 does not receive confirmation that the data was successfully sent and received from the device 16. Thus, the processing server 12 would not have a log that the data was successfully received. With the system of FIG. 10, however, if the device 16 lost signal or retrieval was otherwise disrupted, the processing server 12 is aware and can note such a disruption. As stated, the processing server 12 provides a centralized location for all correspondence with the device 16.

In one embodiment the database housing the unique identifiers 14 is stored on the processing server 12 whereas the actual data is stored on the storage server 223. In one embodiment the user's library is stored on the processing server 12 whereas the actual data is stored on the storage server 223. In such an embodiment information relating to a user's stored data is stored as a user's library on the processing server 12 whereas the actual stored data is located on the storage 223.

FIG. 11 depicts a system of storage retrieval. The system can also be used to store data. As depicted in FIG. 11, the storage server 223 sends data 218 directly to the device 16. As noted, this is contrasted with FIG. 10, above, wherein the data is sent via the processing server 12.

The following examples are for illustrative purposes only and should not be deemed limiting.

In one example, the unique identifier 14 comprises a bar code and an alphanumeric text string such as that depicted in FIG. 5D. The device comprises a smart phone 16 with a camera. The user desires to record a video message. Thus, the user utilizes the device 16 and records data, in the form of a video message, which is saved. The data can be saved directly on the device 16 or it can be saved in a location such that the device 16 has access to the data. The user then resolves the unique identifier with the device by using the device 16 to scan the bar code portion of the unique identifier 14. In one example, the user opens software, either specific or generic, on the device 16 which then prompts the user to scan the unique identifier 14. The device 16 then decodes the unique identifier 14 and sends a query to a processing server 12. The processing server 12 then responds seeking data which is transmitted from the device 16. The device 16 responds by prompting the user to select the data to be stored, and the data is transmitted to the server 12. In one embodiment, the data is stored in a library associated with the user. In one embodiment, the library comprises several pieces of data stored by the user. The user can edit the caption, add text, edit the length of the message, etc. while in the user library. In one embodiment, after accessing the user's library, the user can display and/or edit all of the data in the user's library. Further, as described above, in one embodiment, depending upon the access granted, third-party users may comment and edit within the original user's library.

In another embodiment, after storing the data on the processing server 12, a link to the data, such as a hyperlink, is automatically sent to the original user. In one embodiment, the user is given an opportunity to post the link to Facebook, Twitter, or other social media.

In another example, rather than resolving the unique identifier 14 via scanning, after being prompted by the device 16, the user manually enters the alphanumeric string text. Thereafter, the user selects the data to store, and the data is transmitted to the server 12.

Those skilled in the art to which this invention pertains will readily appreciate that numerous changes, variations and modifications can be made without departing from the scope of the invention mutatis mutandis.

### Additional Description

The following clauses are offered as further description of the disclosed invention.
1. A method for storing data, said method comprising:
   a) resolving a unique identifier with a device, wherein said device comprises data, and wherein said unique identifier comprises a bar code and an alphanumeric text string;
   b) receiving a query at a server from said device; and
   c) transmitting said data from said device to said server.
2. The method according to any preceding clause further comprising creating data, and wherein said creating occurs on said device.
3. The method according to any preceding clause wherein said server consists of a single server.
4. The method according to any preceding clause wherein said creating takes place prior to said resolving step.
5. The method according to any preceding clause wherein said creating takes place after said resolving step.
6. The method according to any preceding clause further comprising d) storing said data on said server.
7. The method according to any preceding clause wherein said server is a processing server and further comprising d) transmitting data from said processing server to a storage server, and
   e) storing data on said storage server.
8. The method according to clause 6 wherein said storing step comprises storing said data in a user library, wherein a user has access to said user library.
9. The method according to clause 6, wherein a user can edit data in said user library.
10. The method according to any preceding clause further comprising a step of determining access to said server, wherein said determining step occurs after step a).
11. The method according to any preceding clause further comprising transmitting a link to said data to a user of said device.
12. The method according to any preceding clause wherein said unique identifier is printed on a label, and wherein said label is affixed to a physical object.
13. The method according to any preceding clause wherein said unique identifier is pre-printed on an object.
14. The method according to any preceding clause wherein said device comprises a mobile device, and wherein said data comprises data which was recorded by said mobile device.
15. A method of obtaining data on a device, said method comprising:
   a) resolving a unique identifier with a device, wherein said unique identifier comprises a bar code and an alphanumeric text string;
   b) receiving a query at a server from said device;
   c) transmitting said data from said server to said device.
16. The method according to clause 15 wherein said unique identifier comprises a matrix barcode encoding a uniform resource identifier of the location.
17. The method according to any preceding clauses 15-16 wherein said server comprises a processing server.
18. The method according to clauses 15-17 wherein said server consists of a single processing server.
19. The method according to clause 17 further comprising a step of d) sending a data request to a storage server, e) receiving data from a storage server, wherein steps d) and e) occur between steps b) and c).
20. The method according to clause 15 wherein said unique identifier is printed on a label, and wherein said label is affixed to a physical object.
21. The method according to clause 15 wherein said unique identifier is pre-printed on an object.
22. A system comprising at least one unique identifier, wherein said at least one unique identifier comprises a barcode and an alphanumeric text string, wherein said bar code and said alphanumeric text string each refers to the location on a processing server which comprises data;
   a device operable to read said unique identifier, wherein said device is capable of accessing said location on said processing server with said unique identifier; wherein said processing server is capable of transmitting data to said device.
23. The system according to clause 22 wherein said unique identifier is printed on a label, and wherein said label is affixed to a physical object.
24. The method according to clauses 22-23 wherein said unique identifier is pre-printed on an object.
25. A system comprising at least one unique identifier, wherein said at least one unique identifier refers to the location on a storage server which comprises data;
   a device operable to read said unique identifier, wherein said device is capable of sending a query to a processing server, wherein said storage server is capable of transmitting data to said processing server, and wherein said processing server is capable of transmitting data to said device, and wherein said storage server cannot communicate with said device.
26. The system according to clause 25 wherein said unique identifier is printed on a label, and wherein said label is affixed to a physical object.
27. The system according to clauses 25-26 wherein said unique identifier is pre-printed on an object.
28. The system according to clauses 25-27 wherein said at least one unique identifier comprises a barcode and an alphanumeric text string.
29. A method of associating, said method comprising:
   a) resolving a unique identifier with a device, and wherein said unique identifier comprises a bar code and an alphanumeric text string;
   b) receiving a query at a server from said device;
   c) transmitting a request to the device;
   d) receiving a link to data from said device; and
   e) associating said unique identifier to said link such that if said unique identifier is resolved, said data can be retrieved through said link.
30. The method according to clause 29 wherein said link comprises a hyperlink.
31. The method according to clauses 29-30 wherein said unique identifier is printed on a label, and wherein said label is affixed to a physical object.
32. The method according to clauses 29-31 wherein said unique identifier is pre-printed on an object.
33. The method according to clauses 29-32 wherein said data is pre-stored data.
34. A method of associating, said method comprising:
   a) resolving a unique identifier with a device, and wherein said unique identifier comprises a bar code and an alphanumeric text string;
   b) receiving a query at a server from said device;
   c) presenting a catalog of pre-stored data to said device;
   d) receiving a selection from said device for at least one selection of pre-stored data; and
   e) associating said unique identifier to said selection such that if said unique identifier is resolved, said pre-stored data can be retrieved.
35. The method according to clause 34 wherein said presenting comprises providing a sampling of said data to said device.
36. The method according to clauses 34-35 wherein said unique identifier is printed on a label, and wherein said label is affixed to a physical object.
37. The method according to clauses 34-36 wherein said unique identifier is pre-printed on an object.

1. A method for storing data, said method comprising:
a) resolving a unique identifier with a device, wherein said device comprises data, and wherein said unique identifier comprises a bar code and an alphanumeric text string;
b) receiving a query at a server from said device; and
c) transmitting said data from said device to said server.

2. The method of claim 1 further comprising creating data, and wherein said creating occurs on said device.

3. The method of claim 2 wherein said server consists of a single server.

4. The method of claim 2 wherein said creating takes place prior to said resolving step.

5. The method of claim 2 wherein said creating takes place after said resolving step.

6. The method of claim 1 further comprising d) storing said data on said server.

7. The method of claim 1 wherein said server is a processing server and further comprising
d) transmitting data from said processing server to a storage server, and e) storing data on said storage server.

8. The method of claim 6 wherein said storing step comprises storing said data in a user library, wherein a user has access to said user library.

9. The method of claim 6, wherein a user can edit data in said user library.

10. The method of claim 1 further comprising a step of determining access to said server, wherein said determining step occurs after step a).

11. The method of claim 1 further comprising transmitting a link to said data to a user of said device.

12. The method of claim 1 wherein said unique identifier is printed on a label, and wherein said label is affixed to a physical object.

13. The method of claim 1 wherein said unique identifier is pre-printed on an object.

14. The method of claim 1 wherein said device comprises a mobile device, and wherein said data comprises data which was recorded by said mobile device.

15. A method of obtaining data on a device, said method comprising:
a) resolving a unique identifier with a device, wherein said unique identifier comprises a bar code and an alphanumeric text string;
b) receiving a query at a server from said device;
c) transmitting said data from said server to said device.

16. The method of claim 15 wherein said unique identifier comprises a matrix barcode encoding a uniform resource identifier of the location.

17. The method of claim 15 wherein said server comprises a processing server.

18. The method of claim 15 wherein said server consists of a single processing server.

19. The method of claim 17 further comprising a step of d) sending a data request to a storage server, e) receiving data from a storage server, wherein steps d) and e) occur between steps b) and c).

20. The method of claim 15 wherein said unique identifier is printed on a label, and wherein said label is affixed to a physical object.

21. The method of claim 15 wherein said unique identifier is pre-printed on an object.

22. A system comprising at least one unique identifier, wherein said at least one unique identifier comprises a barcode and an alphanumeric text string, wherein said bar code and said alphanumeric text string each refers to the location on a processing server which comprises data;
a device operable to read said unique identifier, wherein said device is capable of accessing said location on said processing server with said unique identifier; wherein said processing server is capable of transmitting data to said device.

23. The system of claim 22 wherein said unique identifier is printed on a label, and wherein said label is affixed to a physical object.

24. The method of claim 22 wherein said unique identifier is pre-printed on an object.

25. A system comprising at least one unique identifier, wherein said at least one unique identifier refers to the location on a storage server which comprises data;
a device operable to read said unique identifier, wherein said device is capable of sending a query to a processing server, wherein said storage server is capable of transmitting data to said processing server, and wherein said processing server is capable of transmitting data to said device, and wherein said storage server cannot communicate with said device.

26. The system of claim 25 wherein said unique identifier is printed on a label, and wherein said label is affixed to a physical object.

27. The system of claim 25 wherein said unique identifier is pre-printed on an object.

28. The system of claim 25 wherein said at least one unique identifier comprises a barcode and an alphanumeric text string.
